(19) United States
(12) Patent Application Publication
(10) Pub. No.: US 2008/0291262 A1
(43) Pub. Date: Nov. 27, 2008

(54) VISUAL COMMUNICATION METHOD AND APPRATUS

(75) Inventor: Kang-Sun CHOI, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/123,675

(22) Filed: May 20, 2008

(30) Foreign Application Priority Data
May 21, 2007 (KR) 2007-0049387

(51) Int. Cl. H04N 7/14

(52) U.S. Cl. 348/14.02; 348/14.12; 348/E07.078; 348/E07.077

(57) ABSTRACT

A visual communication method and apparatus that maintain a reliable video quality regardless of variation of source video data amount is provided. The visual communication method includes capturing a video image; filtering video data of a predetermined part of the video image; encoding the video image including filtered video data; and transmitting the encoded video image.

### PRIORITY

This application claims priority under 35 U.S.C. §119(a) to an application entitled “VISUAL COMMUNICATION METHOD AND APPRATUS” filed in the Korean Intellectual Property Office on May 21, 2007 and assigned Serial No. 2007-0049387, the contents of which are incorporated herein by reference.

### BACKGROUND OF THE INVENTION

1. Field of the Invention

The present invention relates generally to a visual communication system and, in particular, to a visual communication method and apparatus that maintain reliable video quality regardless of variation of source video data amount by degrading the less important part of the video data.

2. Description of the Related Art

With the advance of mobile and computing technologies, mobile phones are becoming very powerful and dominant device for mobile computing. Mobile phones have evolved into mobile multifunction terminals incorporating various functions, such as text messaging, visual communication, internet access functions, etc. Recently, mobile phones are commonly equipped with digital camera. Such a convergence of the multimedia functions enables a mobile phone to be a device for playing visual information including still and motion pictures.

A camera phone enables a user to capture a digital picture, which can then be sent to another phone or to an e-mail address. However, since the bandwidth assigned for visual communication is very limited, it has been difficult to transmit real time video data in an acceptable video quality. For this reason, there has been a need for an efficient real time video data transmission technique under a limited bandwidth.

### SUMMARY OF THE INVENTION

The present invention has been designed in an effort to solve at least the above problems. The present invention provides a visual communication method and apparatus that provide reliable video quality in a given bandwidth regardless of variation amount of the video data.

In accordance with an aspect of the present invention, a visual communication method includes capturing a video image; filtering video data of a predetermined part of the video image; encoding the video image including filtered video data; and transmitting the encoded video image.

In accordance with another aspect of the present invention, a visual communication method includes receiving a visual communication data carrying video image, audio data and control signal; demultiplexing the video image, audio data, and control signal from the visual communication data; and playing the video image and audio data according to the control signal.

In accordance with another aspect of the present invention, a visual communication method includes capturing a first video image; filtering video data of a filtering part of the first video image; encoding the first video image; transmitting the first video image; receiving a second video image having a filtering part from another terminal; and displaying the second video image.

In accordance with another aspect of the present invention, a visual communication device includes a camera for capturing a video image; a filter for filtering video data of a predetermined part of the video image; a controller for generating a first visual communication data contained the video image, audio data, and control signal; radio frequency unit for transmitting the first visual communication data carrying a video image and receiving a second visual communication data; and a display for displaying at least one of the transmitted and received video images.

### BRIEF DESCRIPTION OF THE DRAWINGS

The above and other objects, features and advantages of the present invention will become more apparent from the following detailed description when taken in conjunction with the accompanying drawings, in which:

FIG. 1 is a schematic diagram illustrating a visual communication system according to the present invention;

FIG. 2 is a block diagram illustrating a configuration of a mobile terminal equipped with a visual communication apparatus according to the present invention;

FIG. 3 is a conceptual view illustrating the degradation part of a video image to be filtered by the filter unit 130 of FIG. 2;

FIGS. 4A through 4C are exemplary views illustrating a filtering process of the filter unit of FIG. 2; and

FIGS. 5 and 6 are flowcharts illustrating visual communication methods according to the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

In the drawings, certain elements may be exaggerated or omitted or schematically depicted for clarity of the invention, and the actual sizes of the elements are not reflected. Thus, the present invention is not limited in the relative sizes of the elements and distances therebetween.

Although the following describes aspects of the present invention in terms of a mobile handset, it should be clear that the following also applies to other electronic devices, such as cellular phones, digital broadcast receivers, Personal Digital Assistant (PDA), Smart phones, laptop computer, Code Division Multiple Access (CDMA) terminal, Wideband CDMA (WCDMA) terminals, Global System for Mobile Communication (GSM) terminals, General Packet Radio System (GPRS) terminals, and similar communication devices having a process with memory containing firmware and/or application software.

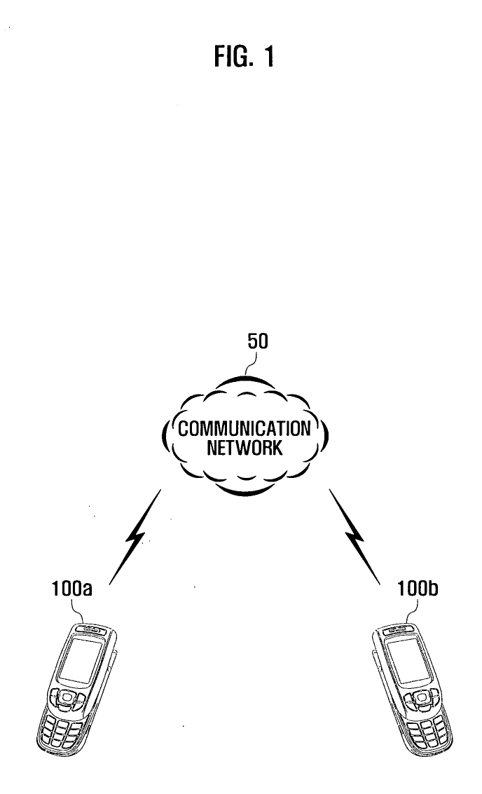

FIG. 1 is a schematic diagram illustrating a visual communication system according to the present invention.

Referring to FIG. 1, the visual communication system includes at least two mobile terminals 100a and 100b communicating via a communication network 50.

The communication network relays visual communication data exchanged between the mobile terminals 100a and 100b. The communication network 50 includes at least one base station, at least on base station controller for controlling the base station, at least one mobile switching center for controlling the base station controller and responsible for switching calls, and a billing server for collecting charging information (not shown). In the following description, in particular, the communication network relays the video data exchanged between the mobile terminals 100a and 100b.

Each of the mobile terminal 100a and 100b is provided with a visual communication module, such as H.264 module. To establish a visual communication link, the mobile terminals 100a and 100b negotiate video quality and frame rate on the basis of their capability. After a visual communication link is established, the mobile terminals 100a and 100b perform visual communication in accordance with the video quality and frame rate of the visual communication link. The video quality and frame rate are maintained in the visual communication session.

During the visual communication session, the mobile terminals 100a and 100b perform filtering on video signals at a part of an image for suppressing high frequency components to reduce the data amount of the image to be coded. Due to the degradation filtering at a part of the image, the other part of the image to which the degradation filtering is not applied is shown as having a higher resolution than the degraded part. The non-degraded part of the image may be assigned additional bits for increasing the resolution during the encoding process. That is, the mobile terminal 100a (or 100b) encodes the video data of a specific part of a transmission image (for example, the circumferential margin of the image) at a low resolution and encodes the video data of the other part of the image (for example, the central part surround by the circumferential margin) at a high resolution, in a given video quality and frame rate. Accordingly, the mobile terminals 100b and 100b enable users to enjoy visual communication with relatively high quality video image.

In more detail, the mobile terminals 100a and 100b negotiate video quality and frame rate in consideration of network and terminal capabilities and establish the visual communication link. Based on the negotiated video quality and frame rate, a control unit of each mobile terminal encodes the video data input through a camera module using different coding scheme for the degradation part and the enhancement part of the image to be transmitted. The degradation is achieved by filtering high frequency components such that the low frequency components, for example zeros of a Discrete Cosine Transform (DCT), increase, resulting in high compression rate at the degradation part of the image. This means that small number of bits are assigned for the filtered part of the image. Accordingly, the saved number of bits can be assigned for improving the resolution at the rest part of the image. By improving the resolution of the user attention area while degrading the resolution of the less attention area, it is possible to transmit user-friendly image in a limited bandwidth for visual communication.

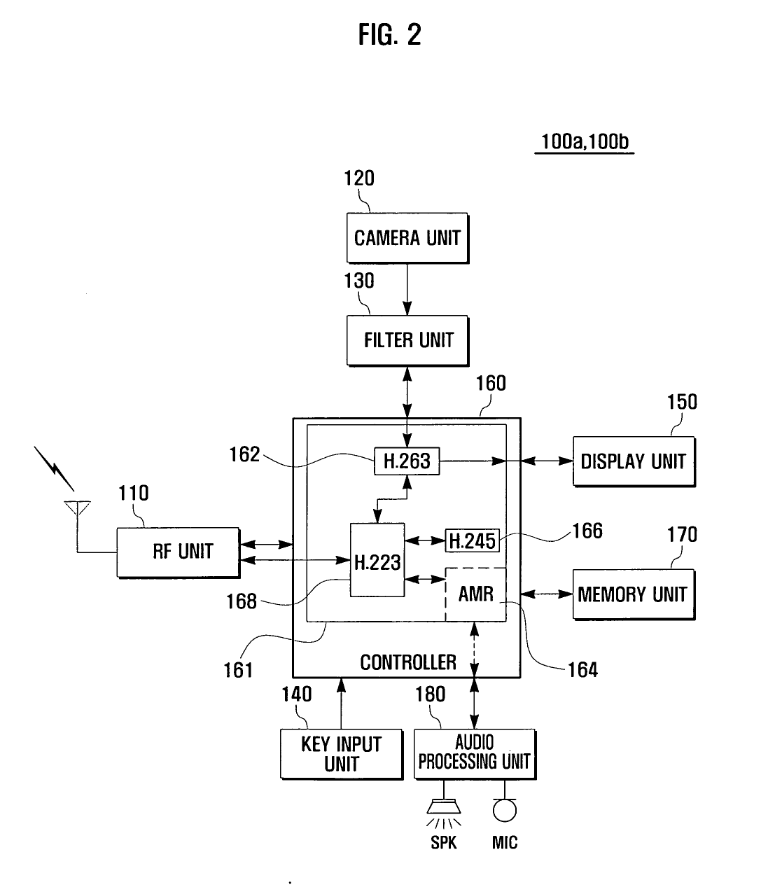

FIG. 2 is a block diagram illustrating a configuration of a mobile terminal equipped with a visual communication apparatus according to the present invention.

Referring to FIG. 2, the mobile terminal 100a (or 100b) includes a Radio Frequency (RF) unit 110, a camera unit 120, a filter unit 130, a control unit 160, a display unit 150, a memory unit 170, a key input unit 140, and an audio processing unit 180.

The RF unit 110 is responsible for transmitting and receiving radio signals, and in particular, representing the video data under the control of the control unit 160. The RF unit 110 includes an RF transmitter for up-converting and amplifying the radio signal to be transmitted and an RF receiver for low-noise amplifying and down-converting the received radio signal.

Particularly, the RF unit 110 transmits and receives the signals for establishing a visual communication link under the control of the control unit 160. The RF unit 110 also transmits and receives the control signals for negotiating the visual communication characteristics, such as video quality and frame rate. In an example that the first mobile terminal 100a has a data rate of 56 kbps and the second mobile terminal 100b has a data rate of 64 kbps, the visual communication link is preferably set up with a maximum data rate of 56 kbps for avoiding bottleneck effect. Such link establishment data can be included in the terminal profiles of the first and second mobile terminals 100a and 100b. Accordingly, the mobile terminals 100a and 100b can obtain the capabilities of counterparty terminals by exchanging the terminal profiles.

The camera unit 120 captures images for use in the visual communication. The camera unit 120 includes a camera sensor (not shown) for picking up light spectrum projected on the lens and converts the light into electrical charges and an analog/digital converter (not shown) for converting the electrical charges, i.e., analog signals, into digital signals. The camera sensor can be implemented with a Charge Coupled Device (CCD) sensor or a Digital Signal Processor (DSP). However, the configuration of the camera sensor is not limited thereto. The camera unit 120 transports the captured image to the filter unit 130. The camera unit 120 also can directly transport the captured image to the display unit 150 for displaying the image in a preview mode.

The filter unit 130 performs filtering on the signals corresponding to a preset degradation part (for example, the circumferential margin) of the image. The filter unit 130 can be implemented with a low pass filter. By filtering the signals of the degradation part, the filtering unit 130 removes the high frequency components distributed in the degradation part. Thus, the resolution of the circumferential margin of the image becomes degraded. Because the high frequency components are removed, the data amount is significantly reduced at the circumferential margin. The operation of the filter unit 130 is described later in more detail.

The control unit 160 controls such that the image of which circumferential margin is degraded in resolution is processed to be fit for the visual communication standard. The video data are combined with audio and control data and then transmitted through the RF unit 110 under the control of the control unit 160. To process the image to be output as the video data for the visual communication, the control unit 160 is provided with a multimedia processing module, such as H.324M module 161 including H.263 module. In this embodiment, the H.263 module is representatively described as the video codec module.

The H.263 module 162 processes the video signals output from the camera unit 120 in unit of frame and outputs the video data in the format appropriate for the characteristics and size of a screen of the display unit 150. At this time, the H.263 module 162 can compress the video data. That is, the H.264 module 162 is responsible for compressing/decompressing the video data to be displayed on the screen of the display unit 150. The H.263 module can be replaced by a Joint Photographic Experts Group (JPEG), Wavelet, Moving Picture Experts Group (MPEG)2, MPEG4, or H.264 codec module. The H.263 module 162 may convert the video data preprocessed by the filter unit 130. That is, in the case that the filter 130 is interposed between the camera unit 120 and the H.263 module 162, the H.263 module 162 performs conversion on the video data preprocessed by the filter unit 130.

The H.324M module 161 multiplexes the video data output by the H.263 module 162 with other data to generate visual communication data and outputs the visual communication data to the RF unit 110. The H.324M module 161 is provided with an audio codec such as Adaptive Multi Rate (AMR) module 164 for encoding audio data output by the audio processing unit 180. The H.324M module 161 also includes a H.245 module 166 for generating control signals such as synchronization signal for synchronizing the video and audio of the visual communication data. The H.324M module 161 also includes an H.223 module 168 for multiplexing the video data from the H.263 module 162, audio data from the AMR module 164, and control signal form the H.245 module 166.

That is, the H.223 module 168 multiplexes the video data, audio data, and control signal to generate the visual communication data and outputs the visual communication data to the RF unit 110.

The key input unit 140 is provided with a plurality of alphanumeric and function keys for receiving numeric and character information and executing various functions. The function keys include navigation keys and shortcut keys. The key input unit 140 transports key sequences input by the keys to the control unit 160.

Particularly, the key input unit 140 is configured to generate a visual communication call request sequence, a filter option enable sequence, and a visual communication end request sequence.

The audio processing unit 180 is provided with a speaker (SPK) for outputting the audio data in the form of audible sound wave and a microphone (MIC) for receiving voice and other sound during the visual communication session.

The display unit 150 is configured to display the video data output from the camera unit 120 in a preview mode. The display unit 150 can be implemented with a Liquid Crystal Display (LCD). In this case, the display unit 150 includes an LCD controller, a video memory for buffering the video data, and an LCD panel (not shown). The LCD display unit can be implemented with a touch screen function. In this case, the display unit 150 can be an input device.

The display unit 150 is preferably configured to display the video image captured by the camera unit 120 and the video image received from the counterpart mobile terminal at the same time. For example, the display unit 150 of the first mobile terminal 100a can be configured such that the video image, i.e., the first video image, input by the camera unit 120 of the first mobile terminal 100a is displayed in a first display window and the video image, i.e., the second video image, received from the second mobile terminal 100b in a second display window. At this time, the first and second video images can be displayed on a same layer in parallel or on different layers in an overlapped form. At least one of the first and second video images can be filtered before being displayed on the display unit 150. Also, the video image input through the camera unit 120 can be displayed in the first display window without video data filtering process.

The first mobile terminal 100a filters the video image input through the camera unit 120, encodes the filtered video image by means of H.263 module 162, and transmits the encoded video image to the second mobile terminal 100b. In the same manner, the second mobile terminal 100b filters the video image input by the camera unit 120 and encoding on the filtered video image by means of the H.263 module 162 and transmits the encoded video data to the first mobile terminal 100a, while displaying the video image before being filtered on the display unit 150.

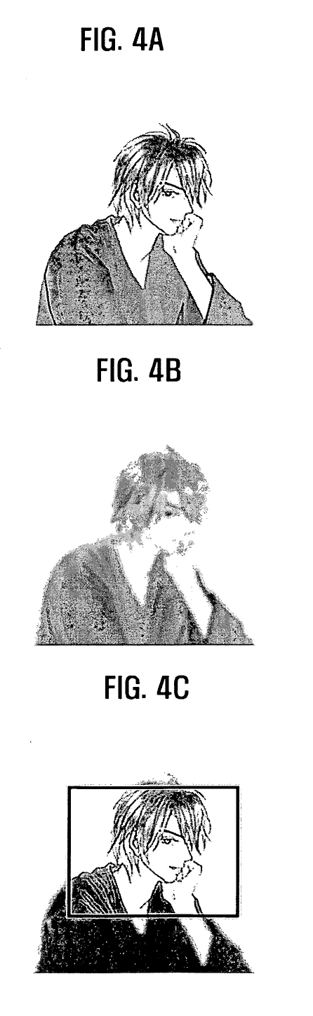

To display the video images in the above-described manner, the filter unit 130 is preferably arranged below the H.263 module 162 of the control unit 160. In this case, the H.263 module 162 is preferably configured to process the video data such that different formats of video images fit for transmission and display are output. Also, both the video images to be displayed on the first and second display windows can be filtered by the filter unit 130. The preprocess on the video images is described later in more detail with reference to FIGS. 4A to 4C.

The memory unit 170 stores application programs for managing the visual communication and camera operations and user data. The memory unit 170 can be configured to buffer the visual communication data in unit of frame. The memory unit 170 can be provided with a program data region for storing the application programs and a user data region for storing the user data.

The program data region stores the operation system for booting the mobile terminal 100a (or 100b), application programs associated with the audio and video processing operations for the visual communication and supplementary functions such as audio and video playbacks. These application programs are activated in response to the user request for executing corresponding functions under the control of the control unit 160.

The data storage region stores the data generated while operating the mobile terminal 100a. Particularly, the data storage region stores the video data recorded during the visual communication and captured by the camera unit 120 and other contents, such as phonebook data, text messages, photos, etc.

As described above, the mobile terminal, i.e., the visual communication apparatus, performs filtering on the video data of a predetermined part (in this embodiment, the circumferential margin) of the video image input through the camera unit 120 using a low pass filter to remove the high frequency components. Accordingly, the visual communication device of the present invention can significantly reduce the amount of the transmission data at the encoding process. Also, the visual communication device of the present invention allows assigning the number of bits saved by degrading the video quality at the circumferential margin to the central part of the image, thereby improving the sensible resolution of the video image.

When a video quality is determined for the visual communication link, the video images input through the camera unit are processed to be fit for the video quality. In this embodiment, filtering the video data at a specific part of the video image to degrade the resolution allows for assigning reduced number of bits for the degraded part at the encoding process. Accordingly, more bits can be assigned for the non-degraded part, whereby it is possible to encode the transmission video data of the non-filtered part of the video image at much higher resolution.

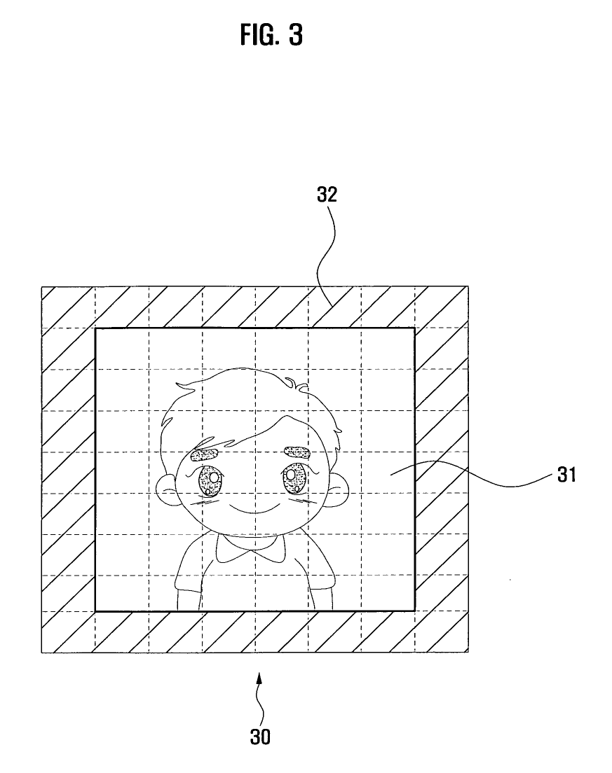

FIG. 3 is a conceptual view illustrating the degradation part of a video image to be filtered by the filter unit 130 of FIG. 2.

As shown in FIG. 3, a video image 30 input by the camera unit 120 is partitioned into a quality enhancement part 31 and a quality degradation part 32 surrounding the quality enhancement part 31. If the video data of the image 30 is input, the filter unit 130 performs filtering on the video data of the degradation part 32. A size of degradation part 32 can be adjusted by the control unit 160. That is, the control unit 160 can extract boundaries between objects and background on the video image input through the camera unit 120 using a histogram technique. Accordingly, the control unit 160 determines the size of the quality degradation part of the image on the basis of the boundary and so the filter size. Also, the filter size can be fixed in consideration of the characteristics of the visual communication link having fixed frame rate and video quality.

The degradation part 32 is preferably established in consideration of boundaries of frequency transform blocks. For example, the video codec such as H.263 and MPEG4 uses luma macroblocks each having a size of 16 pixels. Accordingly, the degradation part 32 is preferably determined on the basis of 16 square coordinate. In FIG. 3, a cell of grid is preferably composed of 16 pixels.

FIGS. 4A through 4C are exemplary views illustrating steps of filtering process of the filter unit of FIG. 2.

As shown in FIG. 4A, a video image input through the camera unit 120 is shown at a relatively higher and entirely regular resolution. In FIG. 4A, a person is shown with clear outline and distinguishable features, and the background is also clear.

FIG. 4B shows an image obtained by compressing and encoding the video image of FIG. 4A to be fit for the visual communication standard. As shown in FIG. 4B, the resolution of the video image is degraded relative to the original video image of FIG. 4A. The object and background of video image is entirely blurred, whereby the boundary between the object and background is not clear.

FIG. 4C shows an image obtained by dividing the video image into the quality degradation part and quality enhancement part and then filtering the video data of the quality degradation part. In FIG. 4C, the quality degradation part is shown at a lower resolution than that of the quality enhancement part. That is, the quality degradation part surrounding the quality enhancement part is blurred such that the boundary between the object and background is not distinguishable. On the other hand, the quality enhancement part maintains the resolution of the original video image input by the camera, such that contour and features of the person are clearly distinguishable from each other.

As described above, the visual communication apparatus of the present invention processes the video image input by the camera unit such that the quality enhancement part of the video image maintains the original resolution while degrading the resolution of the quality degradation part of the video image, thereby providing a visual communication-friendly video image in the limited visual communication bandwidth.

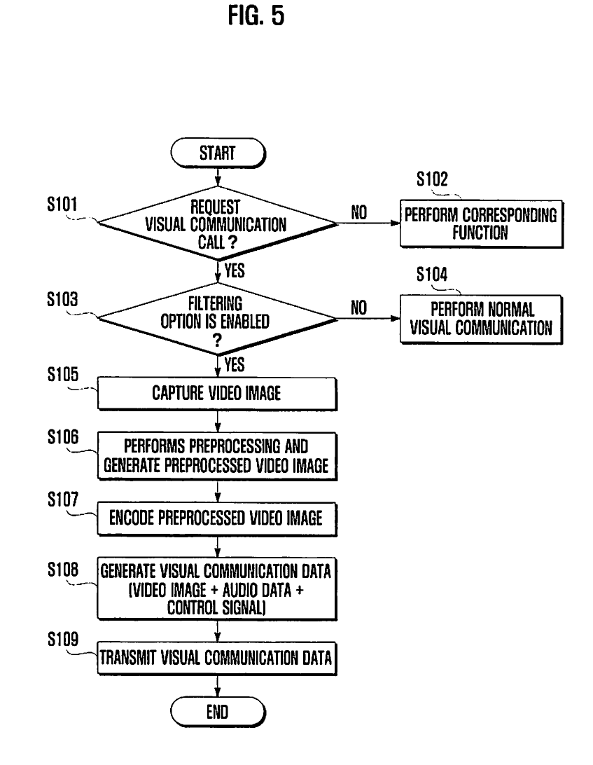

FIG. 5 is a flowchart illustrating a visual communication method according to the present invention.

Referring to FIG. 5, the control unit 160 of the mobile terminal monitors to detect a key input and determines, when a key input is detected, if the key input is for a video call request in step S101. If a key input for requesting a video call is detected, the control unit 160 transmits a call request for establishing a visual communication link to a counterparty phone number. At this time, the mobile terminals exchange terminal profiles defining the capabilities of respective mobile terminals with each other and negotiate the video quality and frame rate. In a case that a video call request is received from another mobile terminal, the control unit 160 transmits its terminal profile to the counterpart terminal and receives the terminal profile of the counterpart terminal and negotiates the video quality and frame rate on the basis of the terminal profiles.

If it is determined that the key is not for the video call request at step S101, the control unit 160 performs a function corresponding to the key input in step S102. The key input can be of executing a voice call function, camera function, audio file playback function, text messaging function, etc.

If a video call request key is input, the control unit 160 determines if a video data filtering option is enabled in step S103. The video data filtering is applied for filtering the video data of the quality degradation part of the video image input through the camera unit 120 using the low pass filter, as described above.

If the video data filtering option is disabled, the control unit 160 controls the mobile to operate in a normal visual communication mode in step S104. In the normal visual communication mode, the filter unit 130 is deactivated such that the video image is compressed and encoded without degradation filtering process as in normal visual communication.

If the video filtering option is enabled, the control unit 160 activates the camera unit 120 to capture an image in step S105. Next, the control unit 160 preprocesses the video data capture by the camera unit 120, i.e., passes the video data of the quality degradation part of the video data through the filter unit 130, to output a preprocessed video image in step S106. At this time, the filter unit 130 performs filtering on the video data of the quality degradation part of the video image using a low pass filter such that the high frequency components of the quality degradation part are removed. The size of the degradation part is preferably fixed in accordance with the visual communication parameters. The quality degradation part of the video image is preferably determined in consideration of the boundaries of frequency transform blocks. The block size can vary according to the video codec. The video codec can be any of H.263 and MPEG4 codecs.

The video image captured by the camera unit 120 are directly transported to the display unit 150 regardless of the setting of the video data filtering option such that the display unit 150 displays the video image at a high resolution before being filtered to be degraded.

Next, the control unit 160 controls compressing and encoding the preprocessed video image and outputs the video data in step S107. At this time, the video code of the control unit 160 performs compression on the preprocessed video image of which the high frequency components are removed through the DCT and motion estimation processes. Accordingly, the video codec can perform encoding at a high speed and secure the high resolution at the quality enhancement party by assigning additional bits to the quality enhancement part as many as bits saved by degrading the video data at the quality degradation part. In other words, the video codec encodes the quality degradation part, at which the high frequency components are removed, with small number of bits. Accordingly, in the case that the number of bits per video image is fixed, the more bits can be assigned for the quality enhancement part than the quality degradation part. As a result, the video codec can encode the video image to secure the high quality and resolution at the quality enhancement part.

Next, the control unit 160 multiplexes the video data encoded by the video codec, the audio data processed by the audio processing unit 180, and the control signals, into a visual communication data in step S108. The multiplexing can be performed by the H.324M module. Finally, the control unit 160 transmits the visual communication data through the RF unit 110 in step S109.

Although the visual communication method is described mainly with the sending party mobile terminal, it can be applied to the receiving party mobile terminal in similar manner. For example, the mobile terminal performs demultiplexing and decoding the visual communication data received from another mobile terminal and processes the video and audio data to be out through the display unit 150 and audio processing unit 180. The display unit 150 can display the video image received from the counterpart mobile terminal in a first display window and the video image input through the camera unit 120 in a second display window, at the same time. In this case, the video image captured by the camera unit 120 can be displayed before or after being filtered by the filter unit 130.

In accordance with an embodiment of the present invention, the size of the quality degradation part can be adjusted according to a movement variation in the video image.

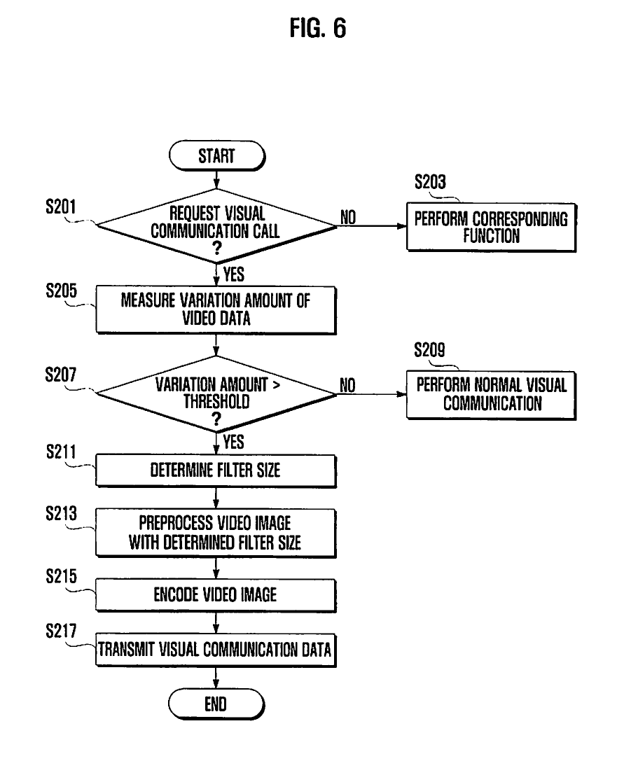

FIG. 6 is a flowchart illustrating a visual communication method according to another embodiment of the present invention.

Referring to FIG. 6, the control unit 160 monitors a key input and incoming call and determines, when a key input or incoming call is detected, if the key input or incoming call is for requesting a video call in step S201. Here, the control unit 160 detects a key sequence input through the key input 140 and establishes a visual communication session. In this procedure, the control unit 160 controls the RF unit 110 for establishing a visual communication link. At this time, the mobile terminals exchange their terminal profiles and negotiate on the video quality and frame rate. When a incoming video call is received from another mobile terminal, the control unit 160 controls to transmit its profile to the counterpart mobile terminal and receives the profile of the counterpart mobile such that the two mobile terminals negotiate a set of parameters for establishing the visual communication link on the basis of the profiles.

If it is determined that the key input or the incoming call is not for the video call request at step S201, the control unit 160 performs a function corresponding to the key input or the incoming call in step S203. The function requested by the key input may be a function related to voice call, camera manipulation, audio file playback, and text messaging, etc.

If a key input or incoming call is detected at step S201, the control unit 160 activates the camera unit 120 and measures a variation of video data amount of video image input through the camera unit 120 in step S205. The variation of the video data amount can be measured using various methods. For example, the data amount variation can be measured by detecting the variations of the pixel values of a specific region of the image. The control unit 160 buffers the pixel values of a predetermined region of the video image captured by the camera unit 120 and compares the current pixel values to the previous pixel values in the predetermined region such that the video data amount variation can be measured on the basis of the comparison result. Also, the control unit 160 can measure the variation of the video data amount using a motion estimator provided with the codec. That is, the motion estimator estimates the motion on the basis of motion vectors, and the control unit 160 measures the variation of the video data amount of the current video image using the motion estimation result. Because the video image is captured in real time, the video data variation amount of the current video image is used for determining the video data variation amount of the next video image.

After measuring the variation of the video data amount, the control unit 160 determines if the variation is greater than a predetermined threshold value in step S207. The threshold value can be varied depending on the variation measurement method and the visual communication link status.

If the variation of the video data amount is less than or equal to the threshold value, the control unit 160 controls the mobile terminal to operate in a normal visual communication mode in step S209. In the normal visual communication mode, the video image captured by the camera unit 120 is transmitted without being preprocessed by the filter unit 130.

If the variation of the video data amount is greater than the threshold value, the control unit 160 sets a filter size of the filter unit 130 in step S211. The filter size is fixed such that the control unit 160 applies the filter size when the variation is greater than the threshold value, but not when the variation is less than or equal to the threshold value. The variation of the video data amount can be sectioned into several variation ranges such that the control unit 160 applies different filter sizes to the respective variation ranges.

After determining the filter size, the control unit 160 controls the filter unit 130 to perform preprocessing on the video data with the filter size in step S213. In the preprocessing process, the video data of the quality degradation part of the video image captured by the camera unit 120 is filtered using a low pass filter. Next, the control unit 160 controls to encode the preprocessed video data in step S215 and transmit the encoded video data to the counterpart mobile terminal in step S217.

As described above, the visual communication method according to an embodiment of the present invention applies a filter to a video image, when the variation of the video data is greater than a predetermined threshold, for preprocessing the video image according to a preset filter size, thereby efficiently transmitting video data in a given visual communication bandwidth. The visual communication method and apparatus preprocesses transmission video image depending on a variation amount of video data such that a high video quality and resolution of an attention part of the video image can be maintained, at a recipient terminal, without increasing bit number in a given bandwidth.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined by the appended claims.

What is claimed is:

1. A visual communication method comprising:
capturing a video image;
filtering video data of a predetermined part of the video image;
encoding the video image including the filtered video data; and
transmitting the encoded video image.

2. The visual communication method of claim 1, wherein the predetermined part of the video image is a circumferential margin of the video image.

3. The visual communication method of claim 2, wherein the circumferential margin is defined in a block unit used for frequency transform of the video image.

4. The visual communication method of claim 1, further comprising establishing a visual communication session defined by a fixed transmission data rate and data size.

5. The visual communication method of claim 4, wherein encoding the video image comprises:
decreasing a number of bits assigned for a circumferential margin; and
increasing a number of bits assigned for a part of the video image surrounded by the circumferential margin as many as a number of bits decreased in the circumferential margin.

6. The visual communication method of claim 1, further comprising displaying the video image.

7. The visual communication method of claim 1, further comprising:
measuring variation amount of the video data of the video image in comparison with a previous video image;
comparing the variation amount to a threshold value; and
determining whether to apply the filtering process.

8. The visual communication method of claim 7, wherein filtering the video data comprises adjusting a filter size according to the variation amount.

9. A visual communication method comprising:
receiving visual communication data carrying a video image, audio data, and a control signal;
demultiplexing the video image, the audio data, and the control signal from the visual communication data; and
playing the video image and the audio data according to the control signal.

10. The visual communication method of claim 9, wherein playing the video image and the audio data comprises:
checking a circumferential margin of the video image;
decoding video data of the circumferential margin of the video image at a low coding rate; and
decoding video data of a part surrounded by the circumferential margin of the video image at a high coding rate.

11. The visual communication method of claim 9, wherein playing the video image and the audio data comprises displaying the video image of which a circumferential margin of the video image is degraded by filtering.

12. The visual communication method of claim 11, wherein the circumferential margin of the video image is defined in a block unit used for frequency transform of the video image.

13. A visual communication method comprising:
capturing a first video image;
filtering video data of a filtering part of the first video image;
encoding the first video image;
transmitting the first video image;
receiving a second video image having a filtering part from another terminal; and
displaying the second video image.

14. The visual communication method of claim 13, further comprising displaying the first video image.

15. The visual communication method of claim 14, wherein the first and second video images are displayed simultaneously.

16. The visual communication method of claim 15, wherein the filtering parts are circumferential margins of the first and second video images.

17. The visual communication method of claim 16, wherein the circumferential margins are defined in a block unit used for frequency transform of the video image.

18. The visual communication method of claim 13, further comprising establishing a visual communication session defined by a fixed transmission data rate and data size.

19. The visual communication method of claim 18, wherein encoding the first video image comprises:
decreasing a number of bits assigned for a circumferential margin; and
increasing a number of bits assigned for a part of the first video image surrounded by the circumferential margin by as many as the number of bits decreased in the circumferential margin.

20. The visual communication method of claim 13, further comprising:
measuring variation amount of the video data of the first video image;
comparing the variation amount to a threshold value; and
determining whether to apply the filtering process to a circumferential margin.

21. The visual communication method of claim 20, wherein filtering the video data comprises adjusting a filter size according to the variation amount.

22. A visual communication device comprises:
a camera for capturing a video image;
a filter for filtering video data of a predetermined part of the video image;
a controller for generating a first visual communication data contained the video image, audio data, and a control signal;
a radio frequency unit for transmitting the first visual communication data carrying the video image and receiving a second visual communication data; and
a display for displaying at least one of the transmitted and received video images.

23. The visual communication apparatus of claim 22, further comprising:
a key input unit for generating a visual communication call request; and
an audio procession unit for processing incoming and outgoing audio data.

24. The visual communication apparatus of claim 22, wherein the filter comprises a low pass filter for filtering the video data of a circumferential margin of the video image.

25. The visual communication apparatus of claim 26, wherein the circumferential margin is defined in a block unit used for frequency transform of the video image.

26. The visual communication apparatus of claim 22, wherein the first visual communication data and the second visual communication data are exchanged at a fixed data rate and size defined in a visual communication session.

27. The visual communication apparatus of claim 26, wherein the controller decreases a number of bits assigned for a circumferential margin and increases a number of bits assigned for a part surrounded by the circumferential margin.

28. The visual communication apparatus of claim 22, wherein the controller measures a variation amount of the video data of the video image, compares the variation amount to a threshold value, and determines whether to apply a filtering process to a circumferential margin of the video image.

29. The visual communication apparatus of claim 28, wherein the filter comprises a low pass filter of which a filter size is adjusted according to the variation amount.
